(19) United States
(12) Patent Application Publication
(10) Pub. No.: US 2021/0131445 A1
(43) Pub. Date: May 6, 2021

(54) BLADELESS FAN

(71) Applicant: Xiaoyi ZHU, Shenzhen (CN)

(72) Inventor: Xiaoyi ZHU, Shenzhen (CN)

(21) Appl. No.: 17/145,399

(22) Filed: Jan. 11, 2021

Related U.S. Application Data
(63) Continuation-in-part of application No. 16/163,539, filed on Oct. 17, 2018.

(30) Foreign Application Priority Data
Oct. 18, 2017 (CN) 201710971763.4

(51) Int. Cl. F04D 29/44; F04D 29/40; F04F 5/16; F04D 25/08

(52) U.S. Cl. CPC F04D 29/441; F04D 25/08; F04F 5/16; F04D 29/403

(57) ABSTRACT

The present disclosure relates to a bladeless fan, which includes a housing and a power device, wherein the power device communicates with a fluid passage and a negative pressure passage disposed in the housing respectively; the fluid passage communicates with the outside through a plurality of exhaust ports, and the negative pressure communicates with the outside through a plurality of suction ports; a middle region inside the fluid passage is provided with a spoiler device so that a path along which the fluid passes through the spoiler device is larger than a path along which the fluid passes around the corresponding inner wall, thereby generating a pressure difference. The present disclosure enables a higher-speed flow of the fluid inside the fluid passage through pressure difference without adding extra power, and generates a faster air speed in a more energy-saving way, thereby achieving a remarkable effect of cooling.

### CROSS-REFERENCE TO RELATED APPLICATIONS

This application is a continuation-in-part of U.S. application Ser. No. 16/163,539 filed on Oct. 17, 2018, which claims the benefit and priority of Chinese patent application No. 201710971763.4 filed on Oct. 18, 2017, the disclosures of which are incorporated herein in their entireties by reference.

### TECHNICAL FIELD

The present disclosure relates to a household appliance, and in particular to a bladeless fan.

### BACKGROUND

The bladeless fan has been widely used as a ventilation and cooling device. Since a large frictional force is generated on an inner wall of the passage of the conventional bladeless fan and energy consumption is therefore caused, the flow rate of the discharged fluid is not high, and the pressure difference from the surrounding air is also not high, thus generating a limited effect of cooling and accordingly making it necessary to improve the bladeless fan.

The inventor discloses a bladeless fan in Chinese patent application No. 201210044426.8, entitled “FAN”; and in Chinese patent application No. 201210116216.5, entitled “PIPE”, the inventor originally discloses a bladeless fan of a fully new structure after years of research on the basis of converting the pressure around the inner wall of the pipe into a source of internal driving force of the pipe.

### SUMMARY

The technical problem to be solved by the present disclosure is to convert the pressure around the inner wall of the pipe of bladeless fan into a driving force of the pipe in the middle region, and to enable a faster and more energy-saving discharged flow rate of the bladeless fan through pressure difference. In order to solve the above technical problem, the following technical solution is adopted by the present disclosure.

A bladeless fan includes a housing and a power device, wherein the power device communicates with a fluid passage and a negative pressure passage disposed in the housing respectively; the fluid passage communicates with the outside through a plurality of exhaust ports, and the negative pressure communicates with the outside through a plurality of suction ports; a middle region inside the fluid passage is provided with a spoiler device so that a path along which the fluid passes through the spoiler device is larger than a path along which the fluid passes around the corresponding inner wall, thereby generating a pressure difference.

The present disclosure also provides another bladeless fan, in which the following technical solution is adopted: the bladeless fan includes a housing and a power device, wherein at least one fluid passage disposed in the housing communicates with the outside through a plurality of exhaust ports, the exhaust ports are disposed in at least one of a front side face, a rear side face, a left side face and a right side face of the housing, and the power device communicates with the exhaust ports through the fluid passage; a middle region inside the fluid passage is provided with a spoiler device so that a path along which the fluid passes through the spoiler device is larger than a path along which the fluid passes around the corresponding inner wall, thereby generating a pressure difference.

The beneficial effects of the present disclosure are set forth herein. As can be known from the common general knowledge, the frictional force generated between the inner wall of the pipe and the fluid is almost the only and the largest energy consumption source in all the pipes.

On the contrary, the present disclosure converts the pressure around the inner wall of the pipe into a driving force inside the pipe in the middle region, so that the fluid in the pipe moves faster, and then is discharged to the outside at a high speed from a plurality of exhaust ports uniformly arranged around the fan to reach a farther distance. Moreover, a very large pressure difference is generated to a larger extent between the fluid and the air flowing at a low speed around the fan so as to form a better air flow, thereby achieving a remarkable effect of cooling.

### BRIEF DESCRIPTION OF DRAWINGS

These and other aspects will become apparent and more readily appreciated from the following description of the embodiments, taken in conjunction with the accompanying drawings in which: FIG. 1 is a front view of a bladeless fan according to a first embodiment of the present disclosure;

FIG. 2 is a cross-sectional view of the bladeless fan according to the first embodiment of the present disclosure;

FIG. 3 is a front view of a circular bladeless fan according to a second embodiment of the present disclosure;

FIG. 4 is a cross-sectional view of the circular bladeless fan according to the second embodiment of the present disclosure; and

FIG. 5 is another front view of the circular bladeless fan according to the second embodiment of the present disclosure.

### DETAILED DESCRIPTION OF THE EMBODIMENTS

The embodiments of the present invention will be described in detail hereinafter, the examples of the embodiments are shown in the accompanying drawings, wherein the same or similar reference numerals throughout the drawings denote the same or similar elements or the elements having the same or similar functions. The embodiments described below with reference to the accompanying drawings are exemplary and are intended to explain the present invention, but cannot be construed as limiting the present invention.

The most critical idea of the present disclosure is to convert the pressure around the inner wall of the pipe into a source of driving force inside the pipe in the middle region.

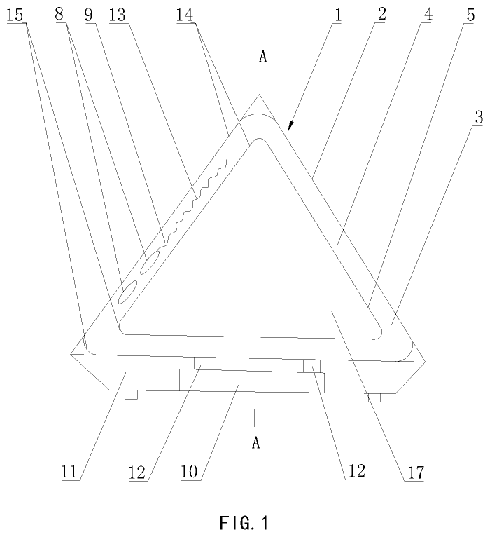

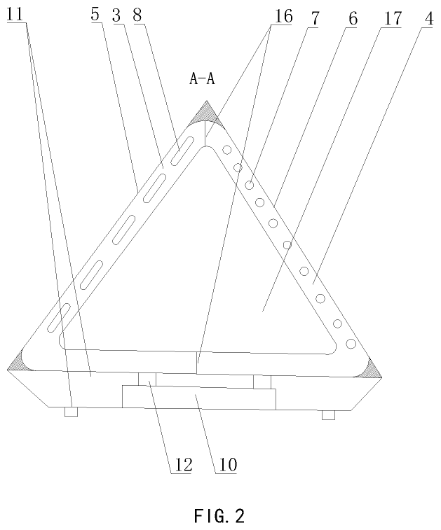

Referring to FIGS. 1-2, a bladeless fan includes a housing and a power device, wherein the power device communicates with a fluid passage and a negative pressure passage disposed in the housing respectively; the fluid passage communicates with the outside through a plurality of exhaust ports, and the power device communicates with the outside through the negative pressure passage and a plurality of suction ports in the housing; the power device communicates with the fluid passage, and a middle region inside the fluid passage is provided with a spoiler device so that a path along which the fluid discharged from the power device passes through the spoiler device is larger than a path along which the fluid passes around the corresponding inner wall, thereby generating a pressure difference.

Further, a middle region inside the fluid passage is provided with a spoiler device so that a high pressure around the inner wall of the fluid passage transfers a pressure difference to a low pressure generated in the middle region, which reduces the frictional force around the inner wall of the fluid passage and converts the pressure around the inner wall into a driving force inside the fluid passage.

Further, the fluid passage disposed in a side face in the front-rear direction of the housing communicates with the outside through a plurality of uniformly distributed exhaust ports, and the negative pressure passage disposed in the other side face of the housing communicates with the outside through a plurality of uniformly distributed suction ports.

Further, the spoiler device is a spoiler face that is concave or convex on the surface thereof, the spoiler face is curved, triangular, trapezoidal or spiral, and the spoiler face extends the fluid passage path.

Further, the shape of the housing is one of the following shapes: diamond shape, pyramid shape, rhombus shape, olive shape, square shape, rectangular shape, triangular shape, curved shape, spherical shape, circular shape or elliptical shape; and the turning portion inside the fluid passage is curved.

Further, a base is further included; preferably, the power device is disposed inside the base, an exhaust end of the power device communicates with the fluid passage through a conduit, and a suction end of the power device communicates with the negative pressure passage through the conduit.

Further, the shape of the housing is preferably one of the following shapes: diamond shape, pyramid shape, rhombus shape, olive shape, square shape, rectangular shape or triangular shape, curved shape, spherical shape, circular shape or elliptical shape; the fluid passage inside the housing is circular or elliptical or curved, and the turning portion inside the fluid passage is curved.

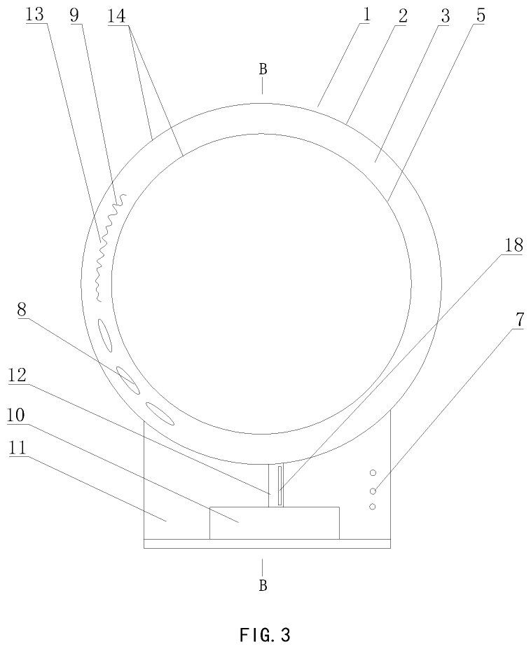

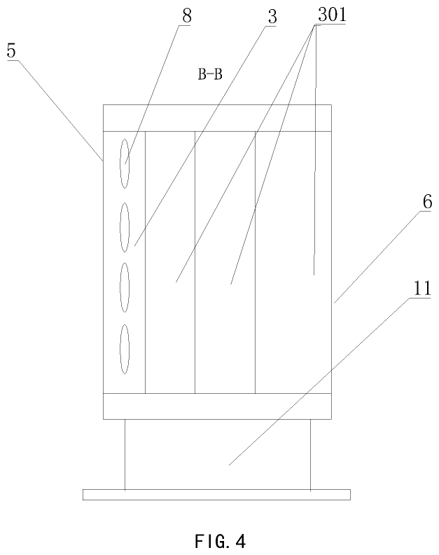

Referring to FIGS. 3-4, the present disclosure further provides a bladeless fan including a housing and a power device; at least one fluid passage disposed in the housing communicates with the outside through a plurality of exhaust ports, the exhaust ports are disposed in at least one of a front side face, a rear side face, a left side face and a right side face of the housing, and the power device communicates with the exhaust ports through the fluid passage; a middle region inside the fluid passage is provided with a spoiler device so that a path along which the fluid passes through the spoiler device is larger than a path along which the fluid passes around the corresponding inner wall, thereby generating a pressure difference.

Further, the power device is disposed inside the housing, an exhaust end of the power device communicates with the exhaust ports of the fluid passage through a conduit, and a suction end of the power device communicates with the outside through suction ports disposed in the housing; the at least one fluid passage communicates with each other to form a pressure from high to low inside the fluid passage and to gradually transfer a pressure difference.

### First Embodiment

Reference is made to FIG. 1, which is a schematic view of a side face 5 of the housing 2. The present disclosure provides a bladeless fan 1, including a tetrahedral diamond-shaped housing 2 and a power device 10, wherein in a side face 5 of the tetrahedral diamond-shaped housing, a fluid passage 3 is disposed around the triangular interior of the housing, and the periphery of the fluid passage 3 communicates with the outside through a plurality of exhaust ports 8; a middle region 13 inside the fluid passage 3 is provided with a spoiler device 9 so that the flow rate of fluid flowing through the middle region 13 of the fluid passage is greater than the flow rate of the fluid passing around an inner wall 14.

Referring to FIG. 2, the fluid passage 3 is disposed in the side face 5 in the front-rear direction of the housing around the triangular interior of the housing, and a negative pressure passage 4 is disposed in the other side face 6 of the housing around the triangular interior of the housing. The periphery of the negative pressure passage 4 communicates with the outside through a plurality of suction ports 7.

The fluid passage 3 in the side face 5 of the housing and the negative pressure passage 4 in the other side face 6 of the housing are separated by a partition 16 in the housing 2 so that the fluid passage 3 and the negative pressure passage 4 are independent and sealed from each other. A middle region between the side face 5 of the housing and the other side face 6 of the housing, preferably a triangular hollow region 17, communicates with the outside at the front and rear.

The power device 10 is disposed inside a base 11. An exhaust end of the power device communicates with the fluid passage 3 through a conduit 12, and a suction end of the power device communicates with the negative pressure passage 4 through the conduit 12.

The shape of peripheral edge of the end face of the side face 5 and the other side face 6 in the front-rear direction of the housing is preferably an inclined surface or a curved surface having a certain angle, and the suction ports and the exhaust ports are disposed in the inclined surface or the curved surface. In addition to aesthetics, the fluid is more easily suctioned and discharged.

The fluid passage 3 is fixedly provided with a spoiler device 9 at the position of its middle region 13 so that a path along which the fluid passes through the middle region 13 of the passage is larger than a path along which the fluid passes around the corresponding inner wall 14, thereby generating a pressure difference.

Specifically, at the position of the middle region 13 inside the passage, a spoiler device 9 for extending the fluid passage path is disposed so that a path along which the fluid passes through the middle region 13 of the fluid passage is larger than a path along which the fluid flows around the inner wall 14 and that the flow rate of the fluid passing through the middle region 13 of the fluid passage is larger than the flow rate of the fluid flowing around the inner wall 14. Therefore, the high pressure generated by the low flow rate around the inner wall 14 necessarily transfers a pressure difference to the low pressure generated by the high flow rate at the middle region 13, and the pressure difference is the driving force, which thereby promotes a rapid fluid movement at the middle region 13.

Further, from ancient times to nowadays, regardless of any pipe under the action of power or external force, the fluid will necessarily generate outward pressure around the inner wall of the pipe, and the pipe is easily broken when the pressure is very high; therefore, under the pressure in the outward direction, a very large frictional force will necessarily be generated between the periphery of inner wall and the fluid; the larger the flow rate is, the greater the frictional force will be, and the greater the generated fluid resistance will be.

Therefore, the frictional force generated between the periphery of inner wall of the pipe and the fluid is almost the only and the largest energy consumption source.

On the contrary, in the present disclosure, the high pressure generated by the low flow rate around the inner wall 14 of the fluid passage 3 necessarily transfers a pressure difference to the low pressure generated by the high flow rate at the middle region 13, and causes a significant reduction in the outward pressure around the inner wall of the pipe; due to the reduction in the pressure, a significant reduction in the frictional force generated between the periphery of the inner wall 14 and the fluid is caused, and the fluid resistance inside the pipe is reduced.

Further, at the position of the middle region 13 inside the passage, a spoiler device 9 for extending the fluid passage path is fixedly disposed, and the outward pressure around the inner wall 14 of the pipe is converted into the inward direction, that is, the pressure is converted into the pressure at the middle region 13 to promote faster movement of the fluid; therefore, the greater the difference between the path along which the fluid passes through the spoiler device 9 and the path along which the fluid passes around the inner wall of the passage is, the greater the pressure difference transferred to the middle region will be, the more the fluid resistance will be reduced, and the greater the generated driving force will be.

Further, the spoiler device 9 may be various spoiler faces that are concave or convex on the surface thereof, and that can extend the fluid passage path. The spoiler device 9 is curved, triangular, trapezoidal or spiral or the like; of course, it is preferable that a curved spoiler face can reduce more fluid resistance.

Further, it is preferred that the surface of the spoiler device 9 is a spiral spoiler face. Due to the special shape of the spiral spoiler face, the fluid flows around the spiral shape one circle by another. Therefore, the path along which the fluid passes through the spoiler device 9 is easily made larger than the path along which the fluid passes around the corresponding inner wall by several ten times or even more. For the paths along which fluid passes, a pressure difference of several ten times is generated due to the difference in flow rate so that the fluid resistance around the inner wall 14 is reduced more and a greater driving force is generated in the middle region 13.

Therefore, the present disclosure converts the pressure around the inner wall of the passage into a driving force of the passage in the middle region 13 without adding extra power, and the flow rate of the fluid in the fluid passage 3 is made higher by the driving force converted due to the pressure difference; therefore, under the action of the pressure difference, the high-speed fluid is discharged to the outside at a high speed from the plurality of exhaust ports uniformly disposed around the fluid passage so as to reach a farther distance. Moreover, a very large pressure difference is generated to a larger extent between the fluid and the air flowing at a low speed around the fan 1 so as to form a better air flow, thereby achieving a remarkable effect of cooling.

Further, the shape of the housing is one of the following shapes: diamond shape, pyramid shape, rhombus shape, olive shape, square shape, rectangular shape, and triangular shape; and the turning portion inside the fluid passage is curved.

Further, the shape of the housing is one of the following shape: circular shape, elliptical shape, spherical shape or curved shape, and the like.

Further, the present disclosure adopts the following technical solution: the pressure around the inner wall 14 of the pipe is converted into a driving force of the pipe in the middle region 13, so that the frictional force between the periphery of the inner wall 14 and the fluid is very small, and the pressure of the inner wall of the passage is converted into an internal driving force, thereby causing the fluid in the passage to move faster. The housing 2 is a diamond-shaped bladeless fan, in which the fluid passage 3 is triangular. Since the frictional force between the periphery of the inner wall 14 of the pipe and the fluid is very small, the turning portion inside the fluid passage is of a curved shape 15, and more importantly, the pressure around the inner wall 14 is converted into a driving force of the pipe in the middle region 13, the high-speed fluid is rapidly rotated in the triangular fluid passage 3 under the driving force in the middle region 13, so that the present disclosure can be easily implemented as a bladeless fan having a structure of a complicated shape such as diamond shape for achieving unique aesthetics and practical effects.

Similarly, the housing can be easily changed to a pyramid shape, a rhombus shape, a square shape, a rectangular shape, a triangular shape, etc., which is a common technique in the art, and it is preferable to set the turning portion inside the passage to have a curved shape 15 so as to facilitate a smooth passage of the fluid. The fluid passage 3 with a fast flow rate can also be formed, so the above structure is also easy to implement.

When the bladeless fan is in operation, the power device 10 generates a very large suction force, which strongly suctions the fluid into the negative pressure fluid passage 4 from the plurality of suction ports 7 evenly distributed around the peripheral edge region of the side face 6 of the housing 2. The fluid is suctioned into the power device 10 through the conduit 12, and is then discharged into the fluid passage 3 from the conduit 12 on the other side of the power device 10. Since the fluid passage has a spoiler device 9 with a spiral spoiler face, the fluid passes through the spoiler device 9 around the spiral shape one circle after another. The spiral shape easily enables the path along which the fluid in the middle region 13 passes to be larger than the path along which the fluid passes around the corresponding inner wall 14 by several ten times or even more, so that a pressure difference of several ten times is generated between the inner wall 14 and the middle region 13 due to the difference in flow rate.

It is obvious that a pressure difference of several ten times is generated between the inner wall 14 and the middle region 13 without adding extra power, and it is easy to reduce the fluid resistance around the inner wall 14 of the fluid passage to a greater extent. A greater driving force is generated in the middle region 13 so as to drive the fluid in the fluid passage 3 to move at a higher speed. The high-speed moving fluid is in turn discharged from the plurality of exhaust ports 8 to the outside so as to reach a farther distance under a very large pressure inside the passage. A very large pressure difference is generated to a larger extent between the fluid and the air flowing at a low speed around the fan 1 so as to form a better air flow, thereby achieving a remarkable effect of cooling.

Further, referring to FIG. 3, a heating element 18 capable of controlling turning on or off and temperature adjustment is provided in the conduit 12 to discharge hot air outward from the exhaust ports 8.

Further, a heating element 18 capable of controlling turning on or off and temperature adjustment is provided in the fluid passage 3 to discharge the required cold and hot air outward from the exhaust ports 8.

Further, the housing 2 of the fan is a blower for blowing hair or other purposes (not shown, and which is common technology in the art) to discharge the required cold and hot air outward from the exhaust ports 8 of the blower.

Further, the housing 2 is a hand dryer used in a restroom (not shown, and which is common technology in the art) to discharge the required cold and hot air outward from the exhaust ports 8 of the hand dryer.

Further, the housing 2 of the bladeless fan is of a diamond shape, and the fluid passage 3 in the housing 2 is preferably circular, elliptical, or curved, with a spoiler device 9 for extending the fluid passage path being disposed at the middle region 13 inside the passage. The circular, elliptical, or curved passage allows the fluid to move faster under the pressure difference, and a higher-speed fluid is discharged outward from the exhaust ports 8 to achieve better cooling effect.

Further, in the middle between the side face 5 of the housing and the other side face 6 of the housing, an enclosed triangular hollow region 17 is formed, that is, the housing 2 of the bladeless fan is a tetrahedral closed diamond type. The fluid passage 3 communicates with the outside through the plurality of exhaust ports 8 uniformly distributed in the side face 5 of the housing, and the negative pressure passage communicates with the outside through the plurality of suction ports 7 in the other side face 6.

Further, the power device is disposed inside the enclosed triangular hollow region 17.

### Second Embodiment

Referring to FIGS. 3-4, the present disclosure provides another bladeless fan 1. The difference from the first embodiment is that the housing 2 is a circular housing and the negative pressure passage 4 is removed. A plurality of suction ports 7 are disposed around the housing 2 at the base 11 for communicating with the power device 10, and a fluid passage 3 is disposed in a side face 5 of the housing 2. The power device 10 communicates the suctioned air with the fluid passage 3 through a conduit 12, and a plurality of exhaust ports 8 are uniformly disposed in the fluid passage 3 for communicating with the outside. The others are the same as above.

Further, the side face 5 and another side face 6 in the front-rear direction of the housing 2 are provided with fluid passages 3 communicating with each other and with the power device, and a plurality of uniformly distributed exhaust ports 8 are disposed in the fluid passage 3 for communicating with the outside.

Further, the fluid passage 3 is disposed in the side face 5 of the housing 2, and an auxiliary fluid passage 301 is disposed in the housing. The auxiliary fluid passage 301 communicates with the fluid passage 3, and the auxiliary fluid passage 301 is not provided with the spoiler device 9 so that the path along which the fluid passes in the auxiliary fluid passage 301 is smaller than the path along which the fluid passes in the fluid passage 3, and that the flow rate in the auxiliary fluid passage 301 is slower than the flow rate in the fluid passage 3. Since the flow rate in the fluid passage 3 is different from that in the auxiliary fluid passage 301, the high air pressure generated by the relatively low flow rate in the auxiliary fluid passage 301 transfers a pressure to the low air pressure generated by the relatively high flow rate in the fluid passage 3, so that the fluid in the auxiliary fluid passage 301 will easily flow into the fluid passage 3 under the action of pressure difference, whereby a longer fluid passage path is formed by the auxiliary fluid passage 301 and the fluid passage 3 together, thereby generating a higher flow rate. Then, the fluid is discharged outward at a high speed from the plurality of exhaust ports 8 around the fluid passage 3.

Similarly, at least one auxiliary fluid passage 301 and the fluid passage 3 communicate with each other, and the auxiliary fluid passage 301 is not provided with the spoiler device 9 so that the flow rate is slower than the flow rate of the fluid passage 3, whereby individual auxiliary fluid passages 301 transfer a pressure difference gradually from high to low, thus causing the fluid to pass along a longer path formed by a plurality of auxiliary fluid passages 301 and the fluid passages 3, and discharging the fluid to the outside at a higher flow rate from the exhaust ports 8.

Further, the fluid passage 3 is provided in the side face 5 of the housing and/or the other side face 6 of the housing, and at least one auxiliary fluid passage 301 is provided in the middle between the side face 5 and the other side face 6 of the housing 2. The auxiliary fluid passage 301 and the fluid passages 3 in the two side faces 5, 6 communicate with each other, and the generated high-rate fluid is discharged to the outside at a high speed from the exhaust ports 8.

Since both side faces 5, 6 are provided with exhaust ports 8 for discharging high-speed fluid to the outside, a very large pressure difference is generated to a larger extent between the fluid and a relatively slow flow of air around the fan, and a better air flow is formed, thereby achieving a remarkable effect of cooling.

Further, the power device 10 is disposed inside the enclosed hollow region 17, and a suction end of the power device 10 is communicated with the outside through suction ports 7 provided on the housing of the enclosed hollow region 17.

Further, the side face 5 and the other side face 6 in the front-rear direction of the housing 2 are respectively provided with a plurality of exhaust ports 8 communicating with the fluid passage 3 in the housing, and a plurality of uniformly distributed exhaust ports 8 are respectively provided on the side faces in the left-right direction of the housing 2 for communicating with the fluid passage 3. That is, a plurality of exhaust ports 8 are uniformly distributed in the front-rear direction and the left-right direction of the housing 2. Since the plurality of exhaust ports 8 uniformly distributed in the front-rear direction and left-right direction of the housing 2 discharge high-speed air outward, a very large pressure difference is generated to a larger extent between the fluid and a relatively slow flow of air around the housing of the fan, and a better air flow is formed, thereby achieving a remarkable effect of cooling.

Further, a plurality of uniformly distributed exhaust ports are provided in at least one of the front side face, the rear side face, the left side face and the right side face of the housing.

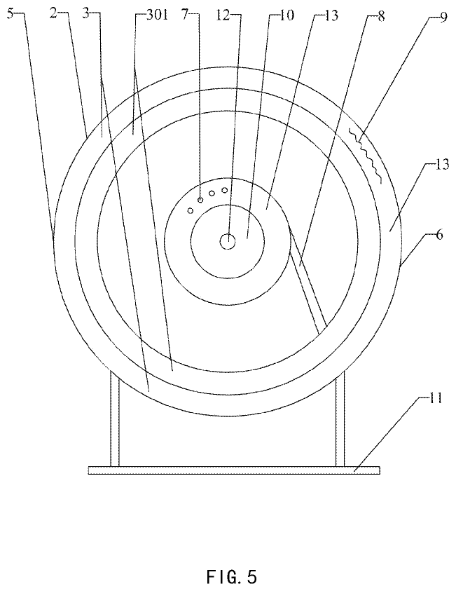

Further, as shown in FIG. 5, the bladeless fan 1 is provided with the circular housing 2 described above; the fluid passage 3 surrounds the housing 2, and the housing 2 is provided with an auxiliary fluid passage 301, the auxiliary fluid passage 301 communicates with the fluid passage 3, and a plurality of uniformly distributed exhaust ports 8 are provided in at least one of the front side face, the rear side face, the left side face and the right side face of the housing 2 and communicate with the fluid passage 3. The power device 10 is disposed inside the enclosed hollow region 17, an exhaust end of the power device 10 is communicated with the fluid passage 3 and the exhaust ports 9 on the front, rear, left, and right sides of the housing 2 through the auxiliary fluid passage 301 by the conduit 12; and a suction end of the power device 10 is directly communicated with the outside through the suction ports 7 of the housing 2 by the conduit 12.

Preferably, the suction end of the power device 10 communicates with the outside through a plurality of suction ports 7 provided on the housing of the enclosed hollow area by the conduit 12, or directly communicates with the outside through the housing by the conduit, or communicates with the plurality of suction ports 7 around the housing of the base 11 by the conduit, and how the suction end of the power device communicates with the outside through the housing by a conduit is the most common technical means.

A spoiler device 9 is disposed at the position of the middle region 13 inside the fluid passage 3, thus the flow rate of the fluid in the middle region and the inner wall is different, resulting in a pressure difference; while there is a pressure difference between low-speed fluid generated by the auxiliary fluid passage 301 without a spoiler device and high-speed fluid generated by the fluid passage 3 due to the difference in flow speed, and the superposition of the pressure causes a higher-speed fluid to be discharged from the exhaust port to the outside.

In summary, the housing of the bladeless fan provided by the present disclosure has a geometric shape, and the fluid passage corresponding to the shape of the housing is curved at a turning portion; or the fluid passage is circular, elliptical, or arc-shaped so that the fluid can smoothly pass through the fluid passage; and then the auxiliary fluid passage is provided in the housing, and the exhaust end of the power device communicates with a plurality of exhaust ports in at least one of a front side face, a rear side face, a left side face and a right side face of the housing through the auxiliary fluid passage and the fluid passage; the pressure difference generated inside the fluid passage is superimposed with the pressure difference between the auxiliary fluid passage and the fluid passage to produce a higher-speed fluid; therefore, the present invention is suitable for the above-mentioned housings of various geometric shapes; the bladeless fan provided by the present disclosure has the advantage of achieving a remarkable cooling effect.

Although the embodiments of the present invention have been shown and described above, it can be understood that the embodiments above are exemplary and cannot be construed as limiting the present invention. Those skilled in the art can change, modify, replace and deform the embodiments above in the scope of the present invention without departing from the principle and purpose of the present invention.

What is claimed is:

1. A bladeless fan, comprising a base, a housing, a power device disposed in the housing, wherein a fluid passage disposed in the housing communicates with an auxiliary fluid passage disposed in the housing;
an exhaust end of the power device communicates with a plurality of exhaust ports on the housing through the auxiliary fluid passage and the fluid passage, the plurality of exhaust ports are disposed in at least one of a front side face, a rear side face, a left side face and a right side face of the housing; and a suction end of the power device communicates with outside through a plurality of suction ports on the housing;
a middle region inside the fluid passage is provided with a spoiler device, so that a path along which a fluid passes through the spoiler device is longer than a path along which the fluid passes around a corresponding inner wall, thereby generating a pressure difference; and
the auxiliary fluid passage is not provided with the spoiler device and communicates with the fluid passage, so that a path along which the fluid passes in the auxiliary fluid passage is shorter than a path along which the fluid passes in the fluid passage, thereby transferring a pressure difference from the auxiliary fluid passage to the fluid passage;
so that the pressure difference generated in the fluid passage and the pressure difference generated between the fluid passage and the auxiliary fluid passage are superimposed so that a higher-speed fluid is discharged from the exhaust port to the outside.

2. The bladeless fan of claim 1, wherein the fluid passage is disposed in a first side face in a front-rear direction of the housing, and the auxiliary fluid passage is disposed in a middle region between the first side face and a second side face of the housing.

3. The bladeless fan of claim 2, wherein the auxiliary fluid passage is disposed between the first side face and the second side face in the housing and communicates with the fluid passage.

4. The bladeless fan of claim 1, wherein more than one auxiliary fluid passage is provided, the more than one auxiliary fluid passages and the fluid passage communicate with each other.

5. The bladeless fan of claim 1, wherein the fluid passage comprises a first fluid passage and a second fluid passage respectively provided in a first side surface and a second side surface in the front and rear direction of the housing, the first fluid passage is disposed in a first side face of the housing, and the second fluid passage is disposed in a second side face of the housing.

6. The bladeless fan of claim 5, wherein the auxiliary fluid passage is disposed between the first fluid passage and the second fluid passage in the front-rear direction of the housing.

7. The bladeless fan of claim 1, wherein the spoiler device is a spoiler face that is concave or convex to extend a path along which the fluid passes.

8. The bladeless fan of claim 7, wherein the spoiler device is curved, triangular, trapezoidal or spiral.

9. The bladeless fan of claim 1, wherein a shape of the housing is one of the following shapes: diamond shape, pyramid shape, rhombus shape, olive shape, square shape, rectangular shape, triangular shape, curved shape, spherical shape, circular shape or elliptical shape; the fluid passage corresponding to the shape of the housing is curved at a turning portion, so that a fluid is able to pass through the fluid passage smoothly.

10. The bladeless fan of claim 9, wherein the fluid passage is circular, elliptical, or arc-shaped, allowing the fluid to pass smoothly through the fluid passage.

11. The bladeless fan of claim 1, wherein the plurality of exhaust ports are uniformly disposed in at least one of a front side face, a rear side face, a left side face and a right side face of the housing.

12. The bladeless fan of claim 1, wherein the power device communicates with the fluid passage through a conduit and the auxiliary fluid passage.

13. The bladeless fan of claim 12, further comprising a heating element capable of controlling turning on or off and temperature adjustment provided in the conduit.

14. The bladeless fan of claim 12, further comprising a heating element capable of controlling turning on or off and temperature adjustment provided in the fluid passage.

15. The bladeless fan of claim 1, further comprising an enclosed hollow region, wherein the power device is disposed in the enclosed hollow region, the suction end of the power device communicates with the outside through the suction ports provided on housing of the enclosed hollow region.
